(19) United States
(12) Patent Application Publication
(10) Pub. No.: US 2025/0083959 A1
(43) Pub. Date: Mar. 13, 2025

(54) High-Yield Atmospheric Nitric Acid Generator for Agricultural Waste Treatment

(71) Applicant: Radom Corporation, West Allis, WI (US)

(72) Inventors: Ian McKinney, Mequon, WI (US); Cory Barthel, Pewaukee, WI (US); Elizaveta Grushnikoa, Milwaukee, WI (US); Qi Rao, Sussex, WI (US); Kenshin Ushiroda, Milwaukee, WI (US); John Koller, Waukesha, WI (US); Nicholas Mantych, Burlington, WI (US); Velibor Pikelja, Milwaukee, WI (US); Ashok Menon, Shorewood, WI (US); Jovan Jevtic, West Allis, WI (US)

(21) Appl. No.: 18/830,067

(22) Filed: Sep. 10, 2024

Related U.S. Application Data
(60) Provisional application No. 63/537,663, filed on Sep. 11, 2023.

(51) Int. Cl. C01B 21/40; C01B 21/32; C01C 1/18; C05C 1/02

(52) U.S. Cl. CPC C01B 21/40; C01B 21/32; C01C 1/185; C05C 1/02

(57) ABSTRACT

A recycling loop nitric acid generator uses a high-pressure nitrogen and oxygen loop with high-temperature plasma to produce concentrated nitric acid suitable for making transportable ammonium nitrate organic fertilizer from scavenged ammonia from manure.

### CROSS REFERENCE TO RELATED APPLICATION

This application claims the benefit of U.S. provisional application 63/537,663 filed Sep. 11, 2023 and hereby incorporated by reference

### BACKGROUND OF THE INVENTION

The present invention relates to the treatment of agricultural waste, such as cow, swine, and chicken manure, and in particular to an economic, on-site nitric acid generator for such use.

Cattle, swine, and chicken farms can produce substantial quantities of manure that present significant odor and environmental contamination issues, for example, from escaping ammonia. Ammonia can be sequestered by treating farm waste with a strong acid, such as nitric acid, which reacts with the ammonia to produce nitrogen enriched fertilizer (ammonium nitrate). It is common for this purpose to use commercial technical grade nitric acid having a concentration from 60 to 70%; however, this material is costly to transport and presents storage and handling challenges.

To reduce the challenges of transporting and handling concentrated nitric acid, it has been proposed to generate nitric acid on-site from nitrogen in the atmosphere. In one such system, atmospheric nitrogen is passed through an electrical plasma to produce nitrogen dioxide that is reacted with water to produce nitric acid.

Systems of this type provide relatively low concentrations of nitric acid (pH 4-6) resulting in a dilute fertilizer unsuitable for transportation and therefore typically used by mixing the resulting fertilizer material directly with the animal waste for on-site use. And the ability to use nitrogen enriched waste requires that the animal facility be closely associated with an agricultural operation that can accommodate large amounts of this material.

### SUMMARY OF THE INVENTION

The present invention provides a method of producing nitric acid from the atmosphere in high concentrations that can be used to produce concentrated nitrogen enriched organic fertilizer for storage or transportation independent from use of the manure. In this regard, the invention provides a recycling, high-pressure reaction yielding nitric acid concentrations in excess of 30% by weight while minimizing energy and scrubbing energy costs. Extracting an independently usable organic fertilizer product from the manure preserves the ability to use the manure in biodigesters for the production of biogas and reduces the risk of environmental contamination when nitrogen enhanced waste materials are applied to cropland in the absence of a growing crop that can use the nutrients.

In one embodiment, the invention provides an agricultural nitric acid generator system having a pressurized gas circulation system operating at an operating pressure of more than 1.3 atm (absolute) to circulate a gas containing nitrogen and oxygen along a gas recycling loop. Positioned along the gas recycling loop are a high-temperature plasma generator receiving the mixture of nitrogen and oxygen to generate nitric oxide, an oxidizer downstream from the high-temperature plasma generator to receive the nitric oxide and react it with oxygen to generate nitrogen dioxide, and a water reactor downstream from the oxidizer to receive the generated nitrogen dioxide and react a first portion of it with a volume of water to produce nitric acid and return a second portion of it to the high-temperature plasma generator along the recycling loop

It is thus a feature of at least one embodiment of the invention to provide a system for high throughput production of nitric acid from the air.

The system may include a computer controller operating to control a recycling of gas through the gas recycling-loop to bring a concentration of nitric acid to water in the water to greater than 30% by weight.

It is thus a feature of at least one embodiment of the invention to produce a nitric acid that can be reacted with free ammonia to produce organic fertilizer that can be economically transported or stored and thus is not limited to being recombined with animal waste for immediate use.

The mixture of nitrogen and oxygen received by the high-temperature plasma generator and the oxidizer maybe free from liquid water.

It is thus a feature of at least one embodiment of the invention permit higher temperature plasma by eliminating the circulation of water and nitric acid residue within the gas recycling loop.

The generator may further include an oxygen source communicating with the recycling loop by a metering valve, and the controller may adjust the metering valve to bring the ratio of oxygen and nitrogen in the gas to a ratio of 1:1 to 1.4 within 10% by volume.

It is thus a feature of at least one embodiment of the invention to adjust the ratio of oxygen and nitrogen found in the atmosphere to boost nitric oxide production.

The generator may include a circulating pump recirculating the gas through the gas recycling loop and providing a differential pressure across an inlet and outlet less than the operating pressure.

It is thus a feature of at least one embodiment of the invention to minimize electrical energy consumption through a pressurized recycling system requiring only a low energy consumption pump for circulating gas.

The agricultural nitric acid generator system may further include a reactor receiving the nitric acid and ammonia from agricultural waste to output ammonium nitrate substantially free from agricultural waste.

It is thus a feature of at least one embodiment of the invention to allow separate streams of waste and fertilizer processing that eliminate the need for disposal of high nitrogen content manure particularly off-season which can lead to environmental contamination.

The operating pressure may be greater than 5 atm.

It is thus a feature of at least one embodiment of the invention to boost process efficiency and reduce equipment cost and size by operating at elevated pressures.

The high-temperature plasma generator may produce a plasma at a temperature in excess of 500° C.

It is thus a feature of at least one embodiment of the invention to accelerate nitric acid production through high-powered plasma generation.

The high-temperature plasma generator may produce a microwave-induced plasma with an energy in excess of 50 kW.

It is thus a feature of at least one embodiment of the invention to provide a plasma-generating technology that can operate at high pressures and temperatures.

The plasma generator may provide a microwave source exciting a dielectric ring separated from the gas by an acid resistant, electrically nonconductive wall of the pressurized gas circulation system.

It is thus a feature of at least one embodiment of the invention to provide a high-powered plasma generator that can be isolated from the corrosive effects of the treated gas.

The agricultural nitric acid generator may further include a scrubber system absorbing nitrogen dioxide and connected to the pressurized gas circulation system for periodic argon venting.

It is thus a feature of at least one embodiment of the invention to reduce scrubber material costs by employing scrubber use only when necessary to flush excess argon or for the purposes of emergency shutdown or service access

The agricultural nitric acid generator may include a heat exchanger downstream from the high-temperature plasma generator for moving heat from the gas to a waste container holding manure and providing an ammonia outlet and may further include a reaction vessel communicating with the water reactor to receive the nitric acid and to react the nitric acid with the ammonia to produce ammonium nitrate.

It is thus a feature of at least one embodiment of the invention to provide a system that can be an efficient part of an on-site animal waste handling systems.

These particular objects and advantages may apply to only some embodiments falling within the claims and thus do not define the scope of the invention.

### BRIEF DESCRIPTION OF THE DRAWINGS

FIG. 1 is a system block diagram showing a nitric acid generator according to one embodiment of the present invention integrated into a waste management system for organic fertilizer production;

FIG. 2 is a detailed block diagram of the nitric acid generator showing a recycling, high-pressure circulation system; and

FIG. 3 is a simplified diagram of an atmospheric oxygen enrichment system that may be used in lieu of stored oxygen.

### DETAILED DESCRIPTION OF THE PREFERRED EMBODIMENT

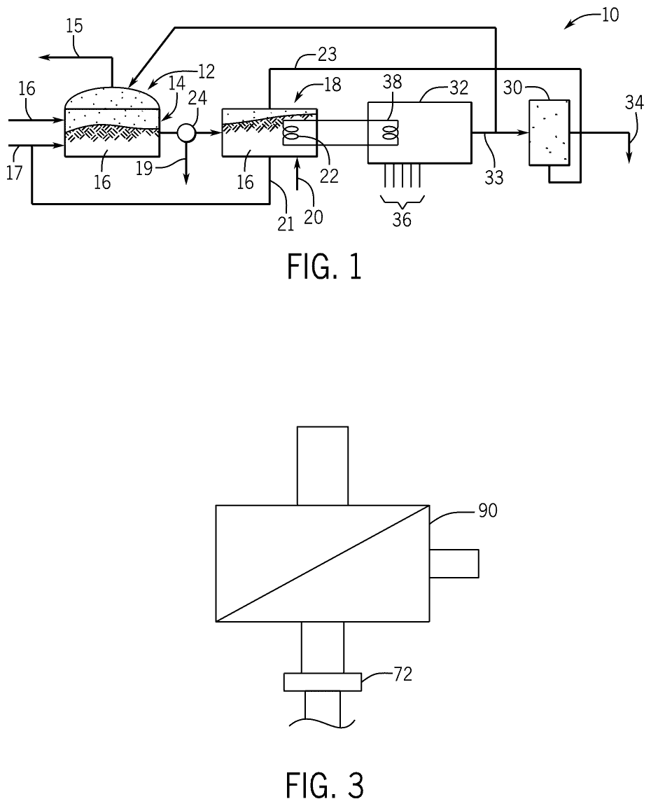

Referring now to FIG. 1, a waste management system 10 suitable for use with the present invention may include an anaerobic biodigester 12 providing a storage volume 14 holding animal wastes 16, for example, cow, pig, or poultry manure, and generating biogas 15 (primarily methane CH₄) that can be used as a fuel source. The animal wastes 16 may be mixed with water 17 to promote digestion of the animal waste 16 by microorganisms such as methanogens and sulfate-reducing bacteria whose microbial processes can be inhibited by high concentrations of free ammonia.

Periodically, waste 16 is removed from the anaerobic biodigester 12 and transported to an ammonia stripper 18, for example, receiving air 20 that is conducted through the waste 16 to scavenge ammonia 23 (NH₃). This stripping process is accelerated by heating the animal waste 16 using heat exchanger 22 whose operation will be described further below.

Prior to the stripping process, the animal waste 16 may be passed through a solid-liquid separator 24 to extract solids 19 which can be used as a bedding material for animals. The ammonia stripper 18 then receives animal waste 16 with reduced solid content. After the stripping process, all or a portion of ammonia-reduced animal waste 21 may be returned to the anaerobic biodigester 12 to reduce the consumption of fresh water 17. The extracted ammonia 23 may be pumped to an absorption column 30 to be combined with nitric acid 33 (HNO₃) generated by an atmospheric nitric acid generator 32 that will be described further below. The reaction of the nitric acid 33 and the ammonia 23 produces an ammonium nitrate fertilizer 34 (NH₄NO₃) that is substantially free from animal waste 16 and thus suitable for isolated storage and transportation on an economic basis. The atmospheric nitric acid generator 32 produces nitric acid 33 of high concentration, for example, greater than 30% or greater than 50% by weight of nitric acid in water solution which, when reacted with gaseous ammonia 23, results in a concentrated organic fertilizer 34 that may be dried and economically stored or transported independent of the waste 16. The ammonium nitrate fertilizer 34 will be a substantially pure solution in water with other ingredients than water and ammonium nitrate comprising less than 10% by weight and typically less than 5% by weight and in some cases less than 2% by weight.

In some cases, nitric acid 33 may be diverted back to the anaerobic biodigester 12 or other points in the transport of the waste 16, such as storage lagoons, to reduce the pH of the waste and further neutralize residual ammonia by converting ammonia o ammonium that is not easily volatilized.

Generally, the atmospheric nitric acid generator 32 receives inputs 36 of air, water, electrical power, makeup gas (one or both of nitrogen and oxygen), and small amounts of scrubbing chemicals, and produces nitric acid and waste heat which is extracted through a heat exchanger 38 that connects to the heat exchanger 22 to provide heat to the ammonia stripper 18.

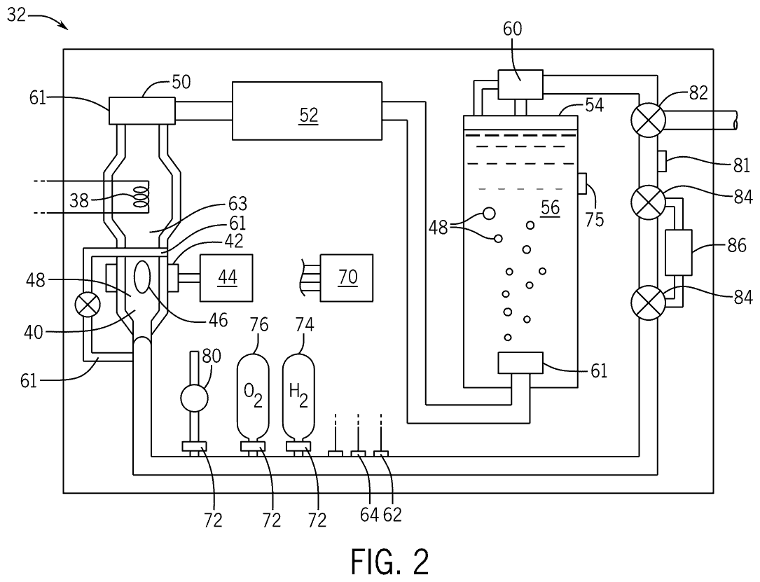

Referring now to FIG. 2, the atmospheric nitric acid generator 32 generally provides a gas recycling loop including a plasma chamber 40 through which a gas mixture 48 (primarily oxygen and nitrogen) flow. The plasma chamber 40 provides an electrically insulating, acid-resistant conduit surrounded by an annular dielectric resonator 42. The annular dielectric resonator 42 is excited by a microwave generator 44 to generate a plasma 46 in the gases 48, as the gases 48 are circulated through plasma chamber 40 under the influence of a circulating pump 50 downstream from the plasma chamber 40. The microwave generator 44 may provide in excess of 10 KW of power and typically will provide in excess of 50 kW or 100 KW of power to produce a plasma 46 having a temperature in excess of 100° C., or in excess of 500° C., and typically in excess of 1000° C. Or in excess of 4000° Kelvin. Importantly, as will be discussed below, the plasma is generated in gas mixture 48 at a pressure in excess of atmospheric pressure and typically at pressures of greater than 1.3 atm, or 5 atm, or more than 10 atm of absolute pressure.

Systems for producing microwave plasma and suitable for this invention are described in US patent publications 2016/0029472 entitled “Plasma Generator Using Dielectric Resonator,” and in U.S. application Ser. No. 17/652,839 filed Feb. 28, 2022, and entitled “High-Power Plasma Torch With Dielectric Resonator,” and in U.S. provisional application 63/521,219 filed Jun. 15, 2023, and entitled “High-Power Plasma Torch With Ignition Detuning,” all assigned to the assignee of the present invention and hereby incorporated by reference in their entirety.

In this embodiment, the microwave-generating electronics including the dielectric resonator 42 are fully shielded from corrosive gases that will be developed within the plasma chamber 40, something that cannot be easily done in conventional arc plasmas or other systems for high-energy, high-temperature plasma generation such as will be necessarily exposed to fouling and shorting from the reaction products. Nevertheless the invention contemplates that other plasma generation techniques may be used accepting this disadvantage.

The plasma chamber 40 is part of a recycling loop circulation system moving gas mixture 48 comprised primarily of a mixture of atmospheric oxygen and nitrogen through the chamber during excitation of the plasma 46. The result is a reaction between oxygen and nitrogen in the gas mixture 48 to form nitric oxide (NO).

Unreacted gas mixture 48 and the generated nitric oxide then pass along the gas recycling loop to the heat exchanger 38 positioned downstream with respect to flow of the gas mixture 48 to remove heat from the flowing gas and to bring it down, for example, to less than approximately 100° C., and preferably less than 40° C., prior to being received by a circulating pump 50. Because the flow of gas mixture 48 through the atmospheric nitric acid generator is pre-pressurized in the gas recycling loop, the circulating pump need not develop a pressure head equal to the operating pressure of the gas mixture 48 with respect to atmosphere but may, for example, have a pressure across the pump 50 operating of less than the operating pressure or less than one half the operating pressure or less than 1 atm. This greatly reduces the energy usage of the system in contrast to a system where atmospheric gas must be constantly pressurized in an open loop. Generally, for a plasma power of 100 kW, the circulating pump 50 will provide a mass flow of greater than 20 g per second and preferably greater than 40 g per second.

Downstream from the circulating pump 50 with respect to flow of the gas mixture 48 is an oxidizer 52 providing a volume in which the nitric oxide (NO) reacts with oxygen to form nitrogen dioxide (NO₂). In one embodiment, oxidizer 52 operates by ensuring a minimum residence or dwell time within the chamber of the oxidizer 52 at the elevated pressures of the gas mixture 48 so that the remaining oxygen in the gas mixture 48 has time to complete this reaction. The physical size of the oxidizer 52 is greatly reduced by operating the gas recycling loop at an elevated pressure as the required volume of the oxidizer 52 is inversely proportional to the cube of the absolute pressure.

The resulting nitrogen dioxide enriched gas mixture 48 from the oxidizer 52 is then passed through an absorption column 54 to allow the nitrogen dioxide of the gas mixture 48 to react with water 56 to form the nitric acid 33. The absorption column 54 may be any of a variety of designs, such as a bubble column, a packed-bed column, or a tray column, but in one embodiment may provide for dispersion of fine bubbles of the gas mixture 48 through a diffuser 61 into a container volume of water 56. The concentration of nitrogen dioxide in these gaseous bubbles will typically be between 1% and 5%.

The reaction between water 56 and the nitrogen dioxide in the gas mixture 48 with one pass through the absorption column 54 (potentially set of columns connected parallelly/subsequently) will be insufficient to provide a high concentration of nitric acid 33 and accordingly the unreacted gas mixture 48 from the absorption column 54 is collected and, after having liquid water removed by a vortex dryer 60, is conducted back to the plasma chamber 40. A portion of the unreacted gas mixture 48 is extracted before the plasma chamber 40 through bypass loop 61 to return to the primary gas flow immediately before the heat exchanger 38 in a swirl chamber 63 serving to centrifugally isolate the hot gas from the plasma 46 away from the loop walls and to cool those gases for rapid quenching of the NO product.

This recycling of the gas mixture 48 the over multiple cycles in which these gases repeatedly past through the gas recycling loop of the plasma chamber 40, the pump 50, the oxidizer 52, the absorption column 54, and the vortex dryer 60 is continued until a desired concentration of nitric acid is produced in the absorption column 54 of above a 30% (less than-0.75 (−log (5.62)) pH) and typically above a 50% (less than −1.02 pH (−log (10.39)) weight ratio of nitric acid with respect to water solution.

During the circulation of gas mixture 48, a pressure sensor 62 and a species sensor 64 may evaluate the pressure of the gas recycling loop and the ratio of oxygen and nitrogen (and possibly other gases such as argon) to make necessary adjustments to account for depletion of the gas constituents during the formation of nitric acid 33. The signals from the sensor 62 and 64 are provided to an industrial controller 70 programmed to control mass flow metering valves 72 that may precisely dispense a controlled mass of gas from more nitrogen tanks 74 and oxygen tanks 76 or an air source 80 of pressurized atmospheric air, for example, from a compressor. Desirably the ratio of nitrogen and oxygen may be controlled to be approximately 50% plus or minus 10% for maximum nitric oxide production.

The controller may initially adjust the metering valve to bring the operating pressure inside the gas recycling loop to above 1.3 atm and adjust the ratio of oxygen and nitrogen in the gas inside the recycling loop to a ratio between 1:1 and 1:4 by volume (or other ratio depending on the optimal). After the initial pressure and gas composition adjustment, the controller may adjust the metering valve to maintain the desired pressure and oxygen/nitrogen ratio to compensate for the absorption of nitrogen and oxygen in the liquid of the absorption column and the loss of gas through the purge valve. It is also contemplated that the system may work with standard atmospheric nitrogen and oxygen ratios at lower efficiency.

The industrial controller 70 may also monitor an acid concentration sensor 75 on the absorption column 54 to determine whether desired acid concentration has been reached and will generally control each of the circulating pump 50, the vortex dryer 60, and the microwave generator 44 and may monitor various temperature monitors (not shown) according to a stored program.

According to this stored program, the controller 70 circulates the gas mixture 48 until a desired concentration of nitric acid 33 is generated in the absorption column 54 while introducing makeup gas and water as needed. When the desired concentration of nitric acid 33 is reached, the nitric acid 33 may be drained from the absorption column 54 which may then be filled with fresh water.

Over time, unreacted argon and other trace gases may build up within the recycling loop requiring a purging of the loop. This may be done, for example, after draining the nitric acid 33 from the absorption column 54 and replacing it with fresh makeup water through valves controlled by the industrial controller 70 (not shown). The remaining gas mixture 48 in the gas recycling loop is then circulated to absorb nitric oxide without activation of the plasma 46. At the conclusion of this operation which reduces nitric oxide to a desired threshold level determined by a nitrogen dioxide sensor 81, the industrial controller 70 operates bypass valves 84 to insert a scrubber 86 into the recycling loop so that any remaining nitric oxide in the gas is 48 is absorbed. The scrubber 86, for example, may be a conduit containing a nitric oxide absorbing material such as is available under the trade name Purafil from Purafil, Inc. of Georgia, USA.

When a sufficiently low nitric oxide concentration has been reached as determined by the industrial controller 70 monitoring the nitrogen dioxide sensor 81, a purge valve 82 may be opened venting the argon and other accumulating gases to the atmosphere and refilling the recycling loop with atmospheric air through air source 80. The purge valve 82 may then be closed and this process described above repeated for the generation of additional nitric acid 33.

It is contemplated that the system can also be setup and run in the continuous mode where nitric: acid is removed continuously or intermittently in short intervals at the maximum rate that allows the acid concentration to remain constant (for example above 30% or above 40%). Water is added continuously or intermittently to maintain water level in the column. The purge valve is operated continuously or intermittently to maintain argon concentration below set limit (for example less than 20% or less than 10% by volume). Purged gas is scrubbed prior to release to atmosphere using a wet scrubber or Purafil.

The present system can produce high concentrations of nitric acid (30%-50%) with continuous plasma operation providing in excess of 5 LPM of NOx gas at concentrations of 2% or higher with efficiencies of 3.0 MJ/mol or better at 10 kW of power or greater

Referring now to FIG. 3, a primary makeup gas of oxygen can be obtained from an oxygen enricher 90 in lieu of the oxygen tank 76, for example, using pressure swing adsorption.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

We claim:

1. An agricultural nitric acid generator system comprising:
a pressurized gas circulation system operating at an operating pressure of more than 1.3 atm to circulate a gas containing a mixture of nitrogen and oxygen along a recycling loop;
a high temperature plasma generator positioned along the recycling loop to receive the mixture of nitrogen and oxygen to generate nitric oxide;
an oxidizer positioned along the recycling loop downstream from the high temperature plasma generator to receive the nitric oxide and react it with oxygen to generate nitrogen dioxide; and
a water reactor positioned along the recycling loop downstream from the oxidizer to receive the generated nitrogen dioxide and react a portion of it with a volume of water to produce nitric acid and return a portion of it to the high-temperature plasma generator along the recycling loop.

2. The agricultural nitric acid generator system of claim 1 further including a computer controller operating to control a recycling of gas through the closed-loop to bring a concentration of nitric acid to water in the water to greater than 30% by weight.

3. The agricultural nitric acid generator system of claim 2 wherein the controller operates to bring a concentration of nitric acid to water to greater than 50% by weight.

4. The agricultural nitric acid generator system of claim 1 wherein the mixture of nitrogen and oxygen received by the high temperature plasma generator and the oxidizer is free from liquid water.

5. The agricultural nitric acid generator system of claim 4 including a liquid water separator positioned upstream of the high temperature plasma generator removed liquid water from the mixture of nitrogen and oxygen prior to receipt by the high temperature plasma generator.

6. The agricultural nitric acid generator system of claim 1 further including a reactor receiving the nitric acid and ammonia from agricultural waste to output ammonium nitrate substantially free from agricultural waste.

7. The agricultural nitric acid generator system of claim 2 further including an oxygen source communicating with the recycling loop by a metering valve and wherein the controller adjusts the metering valve to bring the ratio of oxygen and nitrogen in the gas to a ratio of 1:1 within 10% by volume.

8. The agricultural nitric acid generator system of claim 1 further including a circulating pump in the recycling loop providing a differential pressure across an inlet and outlet less than the operating pressure.

9. The agricultural nitric acid generator system of claim 1 wherein the operating pressure is greater than 5 atm.

10. The agricultural nitric acid generator system of claim 1 wherein the high-temperature plasma generator produces a plasma at a temperature in excess of 500° C.

11. The agricultural nitric acid generator system of claim 1 wherein the high-temperature plasma generator produces a microwave-induced plasma with an energy in excess of 50 kW.

12. The agricultural nitric acid generator system of claim 11 is a microwave source exciting a dielectric ring separated from the gas by an acid-resistant electrically nonconductive wall of the pressurized gas circulation system.

13. The agricultural nitric acid generator system of claim 1 further including a scrubber system absorbing nitrogen dioxide and connected to the pressurized gas circulation system to insert and remove the scrubber system into the gas recycling loop for periodic nitrogen dioxide removal prior to argon venting of the pressurized gas circulation system.

14. The agricultural nitric acid generator system of claim 1 further including a heat exchanger downstream from the high-temperature plasma generator for moving heat from the gas to a waste container holding manure and providing an ammonia outlet and further including a reaction vessel communicating with the water reactor to receive nitric acid and to react the nitric acid with ammonia from the waste container to produce ammonium nitrate.

15. The agricultural nitric acid generator system of claim 1 further including a bypass around the high-temperature plasma generator to conduct a portion of the mixture of nitrogen and oxygen downstream of the high-temperature plasma generator for a portion of the mixture of nitrogen and oxygen passing through the high-temperature plasma generator.

16. A method of producing concentrated nitric acid comprising:
circulating a mixture of nitrogen and oxygen at pressures of more than 1.3 atm within a recycling loop;
treating the mixture of nitrogen and oxygen within the recycling loop with a high-temperature plasma to generate nitric oxide;
reacting the nitric oxide with oxygen to generate nitrogen dioxide;
reacting the generated nitrogen dioxide with water to produce nitric acid;
recycling the mixture of nitrogen and oxygen through the recycling loop to provide a concentrated nitric acid having a concentration in excess of 30% by weight; and
reacting the concentrated nitric acid with gaseous ammonia to produce a substantially pure ammonium nitrate solution.
